(19) United States
(12) Patent Application Publication
(10) Pub. No.: US 2017/0067339 A1
(43) Pub. Date: Mar. 9, 2017

(54) FOAM GENERATOR FOR AN EARTH PRESSURE BALANCE SHIELD TUNNEL BORING MACHINE AND METHOD FOR CONDITIONING REMOVED SOIL MATERIAL AS A SUPPORTING MEDIUM FOR AN EARTH PRESSURE BALANCE SHIELD

(71) Applicants: MC-BAUCHEMIE MÜLLER GMBH & CO. KG, Bottrop (DE); PORR BAU GMBH, Wien (AT)

(72) Inventors: Norbert Hörlein, Wien (AT); Eugen Kleen, Schermbeck (DE)

(21) Appl. No.: 15/120,230

(22) PCT Filed: Feb. 18, 2015
(86) PCT No.: PCT/EP2015/053400

§ 371 Date: Aug. 19, 2016

(30) Foreign Application Priority Data
Feb. 25, 2014 (EP) 14156561.4

(51) Int. Cl. E21D 9/06; B05B 7/00; B01F 5/04; E21D 9/12; B01F 3/04

(52) U.S. Cl. CPC E21D 9/0685; E21D 9/124; B01F 3/04446; B01F 5/0476; B01F 5/0411; B05B 7/0037; B01F 2215/0468; B01F 2215/0081

(57) ABSTRACT

The invention relates to a foam generator (14) for an earth-pressure-balance-shield tunnel-boring machine comprising: a mixing chamber, which has a first inlet opening (22) for a foamable liquid and a second inlet opening (23) for a gas and a foam outlet opening (24); a liquid-feeding device connected to the first inlet opening (22); and a gas-feeding device connected to the second inlet opening (23). The mixing chamber contains a tubular flow chamber (28) having the first inlet opening (22) at one end and the foam outlet opening (24) at the other end. A segment of the flow chamber (28) is designed as a gassing section having a gas-permeable porous wall (26) and adjoins a pressure chamber (29) having the second inlet opening (23) in such a way that the gas fed through the second inlet opening (23) under a pressure enters the flow chamber (28) through the porous wall (26) and, in the flow chamber, mixes with the liquid in such a way that foam is formed. The gas-feeding device and the liquid-feeding device are designed in such a way that the pressure of the fed gas can be set in such a way that the pressure of the fed gas is greater than the pressure exerted on the porous wall (26) by the liquid and that a desired ratio of fed gas to fed liquid is achieved. In a method for conditioning removed soil material as a supporting medium for an earth-pressure balance shield, removed soil is fed to an excavation chamber. Depending on the soil quality, foam is provided in that a foam generator having a gassing section of a specified length, of a specified flow cross-section, and of a specified pore size and pore density is provided and the ratio of fed gas to fed liquid is set in such a way that a desired structure and size of the foam bubbles result. The exiting foam is fed to the excavation chamber and mixed with removed soil.

### FIELD OF THE INVENTION

The invention relates to a foam generator for an earth pressure balance shield tunnel boring machine comprising a mixing chamber, which has a first inlet opening for a foamable liquid and a second inlet opening for a gas and a foam outlet opening, a liquid feeding device connected to the first inlet opening for the foamable liquid and a gas feeding device connected to the inlet opening for the gas, wherein the mixing chamber has a tubular flow chamber having the first inlet opening for the foamable liquid at one end and the foam outlet opening at the other end, and also a method for conditioning removed soil material as a supporting medium for an earth pressure balance shield of a tunnel boring machine, wherein soil is removed and is fed to an excavation chamber of the tunnel boring machine, depending on the quality of the removed soil a foam is provided in that at least one foam generator with a tubular flow chamber is provided and a foamable liquid is fed to the foam generator at one end of a tubular flow chamber, and the foam exiting at the other end of the tubular flow chamber is fed to the excavation chamber and is mixed with the removed soil.

### BACKGROUND OF THE INVENTION

A foam generator for an earth pressure balance shield tunnel boring machine and method for conditioning removed soil material as a supporting medium for an earth pressure balance shield of a tunnel boring machine are known from M. Thewe and C. Budach, “Schildvortrieb mit Erddruckschilden: Möglichkeit und Grenzen der Konditionierung des Stützmediums”, 7. Kolloquium Bauen in Boden und Fels, Technische Akademie Esslingen, 26-27, Jan. 2010, pages 171-183.

In these known foam generators first of all a surfactant solution is provided by mixing water and surfactant and this surfactant is fed to a foam generator and is mixed with air there. The air/surfactant solution mixture is then passed through a flow channel which contains baffles. The baffles comprise grids arranged transversely with respect to the flow direction and/or glass beads arranged in the flow cross-section between retaining screens.

These baffles generate turbulence and, as a result, foam, which is then introduced into the excavation chamber.

The structure and magnitude of the foam bubbles thus generated are more or less

[symbol]

Furthermore, a foam injector is known from the Utility Model DE 20 2004 015 637 U1, in which compressed air flows into a tubular flow channel at one end and a liquid foaming agent is sprayed onto a baffle plate arranged transversely to the air flow, then at the other end of the flow tube the swirling mixture of air and foaming agent is pressed through a porous foam generator covering the flow channel, wherein on the other side of the foam generator the foam which is formed enters a housing volume and leaves the housing via an outlet opening.

### SUMMARY OF INVENTION

The object of the invention is to create a foam generator or a method of the type referred to above, which enables the structure and size of the generated foam bubbles to be tailored to the quality of the outcropping soil and at the same time enables additives, such as in particular solid components, to be mixed into the foam which is formed.

The foam generator according to the invention for an earth pressure balance shield tunnel boring machine comprises a mixing chamber which has a first inlet opening for a foamable liquid and a second inlet opening for a gas and a foam outlet opening, a liquid feeding device connected to the first inlet opening for the foamable liquid and a gas feeding device connected to the inlet opening for the gas. In addition to a first and a second inlet opening as well as an outlet opening, further such inlet or outlet openings can be provided. The mixing chamber has a tubular flow chamber having the inlet opening for the foamable liquid at one end and the foam outlet opening at the other end. This tubular flow chamber basically does not need to have either a constant cross-section or a circular cross-section and, furthermore, can also be curved. A segment of the tubular flow chamber is designed as a gassing section with a gas-permeable porous wall. The segment of the tubular flow chamber designed as a gassing section is surrounded by a pressure chamber. The pressure chamber includes the inlet opening for the gas and surrounds the segment of the tubular flow chamber designed as a gassing section in such a way that the gas fed through the inlet opening under pressure enters the flow chamber through the gas-permeable porous wall and, in the flow chamber, mixes with the foamable liquid in such a way that foam is formed. The gas feeding device and the liquid feeding device are designed in such a way that the pressure of the gas fed to the pressure chamber can be set in such a way that the pressure is greater than the pressure exerted on the gas-permeable porous wall by the liquid and that a desired ratio of fed gas to fed liquid is achieved.

A fundamental idea of the invention is that close meshed barriers, such as gratings, retaining screens or glass bead packings or the porous foam generator known from the above-mentioned utility model, are kept out of the flow path between the surfactant solution inlet and the foam outlet opening, because such close meshed barriers can become clogged by particles contained in the solution.

In a preferred embodiment of the method according to the invention the gas feeding device and the liquid feeding device are designed in such a way that the pressure of the gas fed to the pressure chamber can be set in such a way that the pressure is 0.5 to 2 bars, preferably 1 to 2 bars, greater than the pressure of the liquid. This enables sufficient access of air for a required ratio between the foam volumetric flow and the liquid feed, i.e. a desired FER (foam expansion ratio).

The pressure chamber can adjoin the flow chamber on one side; it preferably surrounds or encloses the flow chamber partially or completely (with the exception of the inlet and outlet opening).

In one embodiment the segment of the tubular flow chamber designed as a gassing section has a constant flow cross-section. The segment of the tubular flow chamber preferably also has a circular cross-section. This simplifies the production.

In one embodiment of the foam generator the segment of the tubular flow chamber designed as a gassing section is a hollow cylinder having a gas-permeable porous wall and extending between the inlet opening for the foamable liquid and the foam outlet opening. The hollow cylinder preferably has a gas-permeable porous wall of constant thickness.

In a preferred embodiment the fed gas is air (i.e. compressed air) and the gas feeding device comprises a compressor. In this case the foamable liquid is a water/surfactant mixture and the liquid feeding device comprises a water/surfactant mixing device, by which the quantitative ratio of water and surfactant can be set.

In the method according to the invention for conditioning removed soil material as a supporting medium for an earth pressure balance shield of a tunnel boring machine, soil is removed and is fed to an excavation chamber of the tunnel boring machine. Depending on the quality of the removed soil a foam is provided in that at least one foam generator with a tubular flow chamber is provided and a foamable liquid is fed to the foam generator at one end of a tubular flow chamber, and a gas which mixes with the foamable liquid in such a way that foam is formed is fed to a segment of the tubular flow chamber designed as a gassing section through the gas-permeable porous wall thereof, and the gas is fed, at a pressure greater than the pressure exerted on the gas-permeable porous wall by the liquid, to a pressure chamber which encloses the segment designed as a gassing section. In this case—depending on the quality of the removed soil—a foam generator having a gassing section of a specified length, of a specified flow cross-section, and of a specified pore size and pore density is provided and the ratio of fed gas to fed liquid is set in such a way that a desired structure and size of the foam bubbles result. The foam exiting at the other end of the tubular flow chamber is fed to the excavation chamber and mixed with the removed soil.

In a preferred modification of the method according to the invention the gas is fed to the pressure chamber at a pressure 0.5 to 2 bars, preferably 1 to 2 bars, greater than the pressure of the liquid. This enables a desired ratio between the foam volumetric flow and the liquid feed, i.e. a desired FER (foam expansion ratio).

In a preferred modification of the method according to the invention the foam is fed to the excavation chamber at a pressure 1 to 2 bars greater than the pressure in the excavation chamber. This enables the required amounts of foam to be pressed in.

The foam exiting from the tubular flow chamber is preferably fed to a plurality of injection points in the excavation chamber in order to achieve a desired distribution of the foam. In this case the foam exiting from the tubular flow chamber can be fed to injection points on a cutting wheel and also to a side of a pressure wall facing the excavation chamber. In addition, the foam exiting from the tubular flow chamber can be fed to injection points in a screw conveyor which conveys the removed soil from the excavation chamber.

In a preferred modification of the method for conditioning removed soil material as a supporting medium for the earth pressure balance shield of a tunnel boring machine, a solid material is fed together with the foamable liquid to the foam generator at one end of the tubular flow chamber. The solid material preferably contains a bentonite powder or bentonite granulate. In this case a barrier-free flow of the surfactant solution through the flow channel is preferred.

In a preferred embodiment, depending on the quality of the removed soil, the foam generator having a gassing section of a specified length, of a specified flow cross-section, and of a specified pore size and pore density is provided by selecting a hollow cylinder serving as a gassing section for the foam generator on the basis of parameters of the removed soil, the hollow cylinder having a specified length and specified internal cross-section with a gas-permeable porous wall of specified pore size and pore density. This enables simple adaptation of the foam composition to changing soil conditions. The differently designed hollow cylinders serving as gassing sections can be simply replaced.

Alternatively, in one embodiment a plurality of gassing sections can be arranged parallel in terms of flow, wherein from the plurality of gassing sections arranged parallel in terms of flow one gassing section with the selected parameters is selected by shutting off the feeding of liquid gas to the other gassing sections.

Advantageous and/or preferred modifications of the invention are characterised in the subordinate claims.

### BRIEF OF DESCRIPTION OF THE DRAWINGS

The invention is explained below with reference to preferred embodiments which are illustrated in the drawings. In the drawings:

FIG. 1 shows a schematic representation of a tunnel boring machine with the elements essential for the invention;

FIG. 2 shows a schematic longitudinal sectional view of a foam generator according to the invention; and

FIG. 3 shows a schematic cross-sectional view of the foam generator according to FIG. 2.

### DETAILED DESCRIPTION

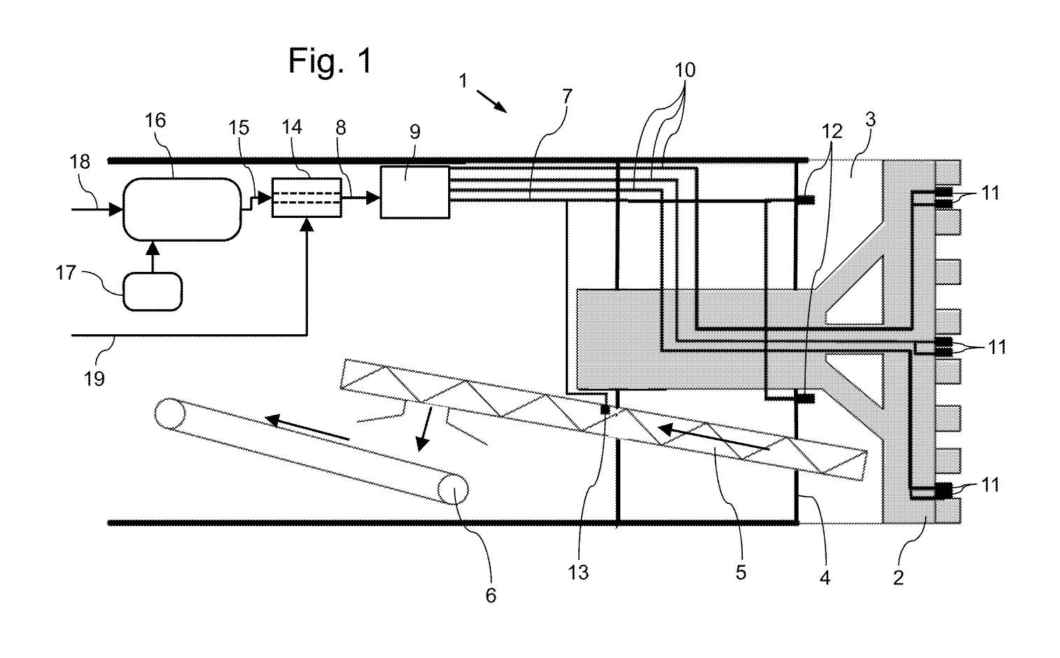

FIG. 1 shows schematically several elements of a tunnel boring machine 1 which are essential for the present invention. With the aid of scraper blades and cutting rollers a cutting wheel 2 removes the soil at a working face of the tunnel. The removed soil then falls into an excavation chamber 3. The excavation chamber 3 is delimited on the rear side by a pressure wall 4 of the tunnel boring machine 1. In the excavation chamber 3 the removed soil is mixed thoroughly with the aid of mixing blades, which are located both on the cutting wheel 2 and also on the pressure wall 4, and is usually blended with conditioning agents. The mixture formed in the excavation chamber 3 is then extracted by means of a screw conveyor 5 from the excavation chamber 3 and is guided onto a conveyor belt 6 for removal. The quantity extracted from the excavation chamber 3 and thus the necessary supporting pressure are regulated by means of the rotational speed of the screw conveyor 5. The propulsion is regulated by means of hydraulic drive cylinders (not illustrated in FIG. 1), which are supported on the rear side on a most recently erected tunnel ring, the tunnel ring being made up of reinforced concrete segments referred to as tubbings.

Naturally grown soils often do not have the geological characteristics that would be necessary so that only the removed soil can serve as supporting medium in the excavation chamber. Therefore conditioning agents are added. Currently water, clays (inter alia bentonite), polymers and foams are used as conditioning agents in earth pressure balance shields. Whereas water, clays and polymers are used primarily for the conditioning of fine-grained soils, in the case of coarse-grained soils surfactant foams are usually introduced into the excavation chamber 3 filled with loosened soil in order to condition the soil. The surfactant foams normally consist of a majority of air, a proportion of water and a small quantity of a surfactant.

For production of the surfactant foams, first of all a surfactant solution is provided, and water and surfactant are brought together in a predetermined ratio and blended to make the surfactant solution. FIG. 1 shows a surfactant solution tank 16, to which a surfactant from a storage container 17 and water are fed via a conduit 18. The surfactant solution is fed via a conduit 15 to a foam generator 14. At the same time compressed air is fed to the foam generator 14 via a conduit 19. A control device (not shown in FIG. 1) ensures that the surfactants and the fed water are mixed in a predetermined ratio and fed to the tank 16, and that the surfactant solution is fed via the conduit 15 and the compressed air is fed via the conduit 19 in a predetermined quantitative ratio and at predetermined pressures to the foam generator 14.

In the foam generator 14 which is described in greater detail below a foam is generated from the surfactant solution and the compressed air and is then fed via a conduit 8 to a distributor 9. The distributor 9 distributes the foam via conduits 10 at injection points 11 in the cutting wheel 2 and via further conduits 7 at injection points 12 on the pressure wall 4 as well as injection points 13 in the screw conveyor 5.

A control device (not illustrated in FIG. 1) controls the quantities of foam fed to the respective injection points 11, 12 and 13 by corresponding control of the control valves arranged in the conduits.

FIG. 1 shows schematically only one foam generator 14. In alternative and/or preferred embodiments a plurality of foam generators can also be provided which can alternatively be coupled into the flow path and can also generate different foams. Alternatively, separate foam generators can also be provided for the different injection points, which makes it possible for the parameters of the foams which are injected at the different injection points to be adapted to the quality of the mixture at the respective injection points.

During the driving the quality of the soil can change, so that the parameters of the foam, such as for example the ratio of air and liquid or the size of the foam bubbles, can be varied depending upon the ascertained soil quality until a result which is satisfactory for driving is achieved. An optimal pore size of the surfactant foam can be determined by preliminary tests for any soil composition which may be encountered. On the basis of these experimentally determined correlations it is then possible, with the aid of the foam generator according to the invention and described in greater detail below, to set the foam parameters, such as for example the foaming rate FER and the foam pore size, as a function of the outcropping soil. Furthermore, the foam generator 14 according to the invention makes it possible for a proportion of solids, for example a clay (in particular bentonite), to be added in addition to the surfactant solution fed via the conduit 15. This serves for example for the stabilization of loose soils. The field of use of earth pressure balance shields is widened by this possibility.

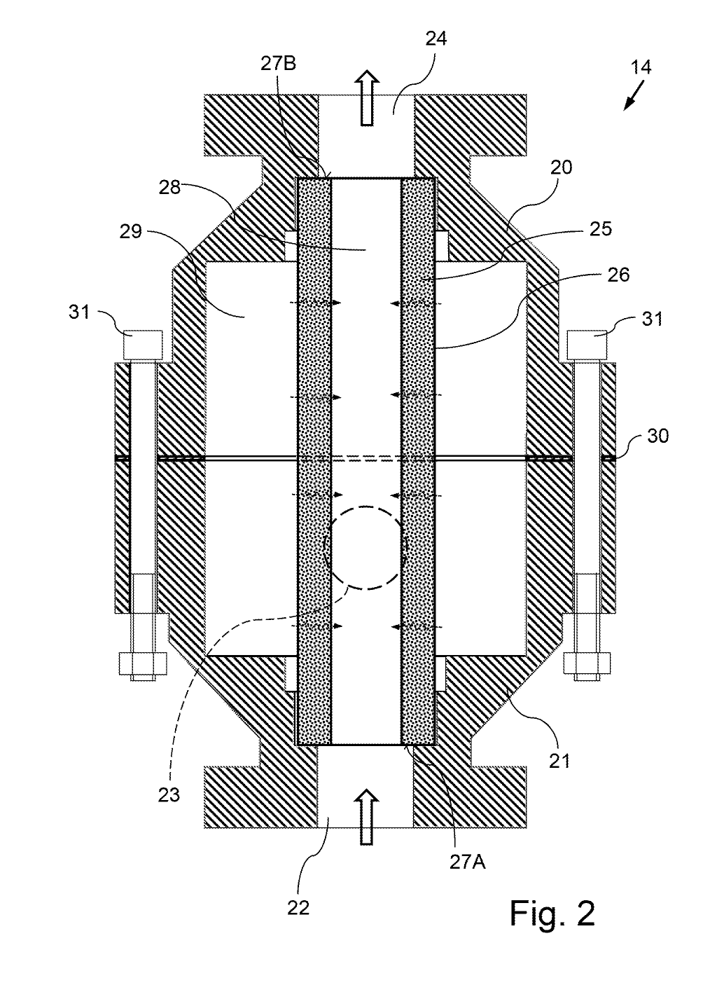

FIG. 2 shows a schematic longitudinal sectional view of the foam generator 14 according to the invention. A housing consists of two housing shells 20, 21 which are pressed together by means of bolts 31, with a seal 30 arranged between the housing halves 20 and 21. The housing half 21 shown at the bottom in FIG. 2 has an inlet opening 22 into which a surfactant solution can enter. The upper housing shell 20 has a foam outlet opening 24. In the interior of the foam generator 14 a hollow cylinder 25 with a porous wall 26 is arranged between the housing shells 20 and 21 in such a way that an end face 27A of the hollow cylinder 25 rests tightly against an end wall of the housing shell 21, so that all of the surfactant liquid flowing into the inlet opening 22 enters a flow chamber 28 in the interior of the hollow cylinder 25. On the opposite side the other end face 27B of the hollow cylinder is likewise tightly connected to an end face of the housing shell 20, so that all of the foam exiting from the flow chamber 28 exits from the outlet opening 24.

If the housing shells 20 and 21 are separated from one another, the hollow cylinder 25 with the porous wall 26 can be inserted between the housing shells 20 and 21, so that after the assembly and the tightening of the bolts 31 the hollow cylinder bears with its end faces 27A and 27B on sealing surfaces of the housing shells and also both housing shells are pressed tightly onto one another. In the interior of the housing shells 20 and 21 a pressure chamber 29 surrounds the hollow cylinder 25. This pressure chamber 29 is connected to an inlet opening 23 for compressed air. The compressed air flowing into the pressure chamber 29 via the inlet opening 23 penetrates into the flow chamber 28 via the pores of the wall 26 of the hollow cylinder 25, so that small air bubbles of the surfactant solution flowing through the flow chamber 28 are mixed in. This produces a foam which exits through the outlet opening. The pore size of the foam as well as the ratio between liquid and air, i.e. the foaming rate, depend on the one hand upon the dimensions of the hollow cylinder and the pore size of the wall 26, and on the other hand upon the pressure conditions, i.e. the pressure of the air in the pressure chamber 29 and the pressure of the liquid at the inlet opening 22 as well as the pressure in the excavation chamber 3 connected to the outlet opening 24. In this case it should be noted that the pressure of the foam at the outlet opening 24 should preferably be 1-2 bars above the pressure in the excavation chamber 3. The air pressure in the pressure chamber 29 is then between 1 and 2 bars above the pressure of the surfactant/water mixture at the inlet opening 22. At the pressures usually occurring in the excavation chamber 3 an air pressure 1.5-6.5 bars is produced in the pressure chamber 29.

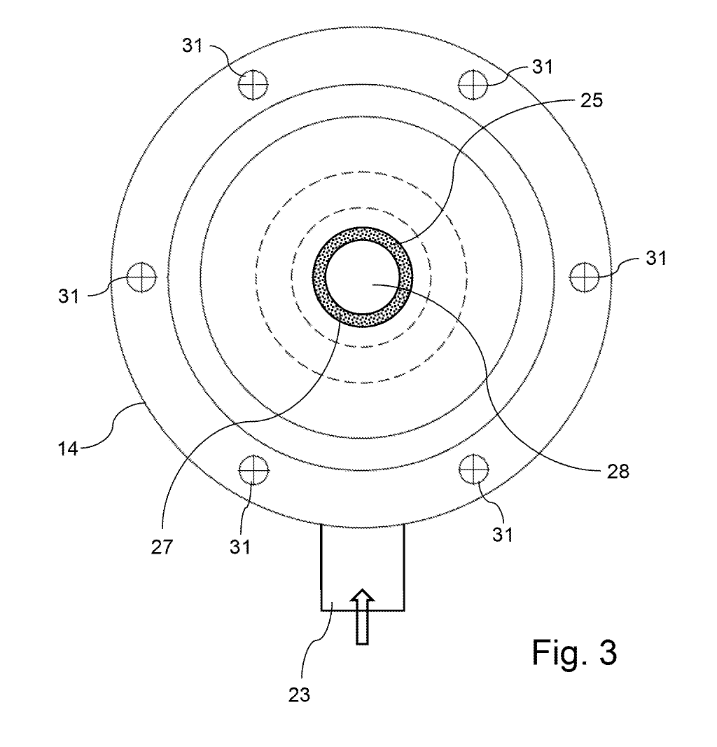

FIG. 3 shows a cross-sectional view of the foam generator 14 shown schematically in FIG. 2. In the illustrated exemplary embodiment, the two housing halves 20 and 21 are held together by six bolts 31. FIG. 3 shows the connector flanged radially onto the housing shell 21 with the air inlet 23.

Within the context of the idea underlying the invention numerous alternative embodiments are conceivable. For example, a plurality of parallel hollow cylinders with flow chambers 28 can be arranged in the pressure chamber formed by the housing shells 20, 21. Conversely, it is also conceivable that a pipe which is, for example, concentric with a porous wall is arranged within a cylindrical flow chamber through which the surfactant liquid flows, wherein the compressed air is fed to the interior of this pipe, so that the air is pressed outwards via the porous wall into the flow chamber surrounding it. In yet another embodiment the porous walls can be planar panels between one or several pressure chambers and one or several flow chambers, wherein the chambers are arranged parallel adjacent to one another.

1. A foam generator for an earth pressure balance shield tunnel boring machine comprising:
a mixing chamber, which has a first inlet opening for a foamable liquid and a second inlet opening for a gas and a foam outlet opening (24),
a liquid feeding device connected to the inlet opening for the foamable liquid, and
a gas feeding device connected to the inlet opening for the gas,
wherein the mixing chamber has a tubular flow chamber having the inlet opening for the foamable liquid at one end and the foam outlet opening at the other end,
wherein
a segment of the tubular flow chamber is designed as a gassing section with a gas-permeable porous wall,
the segment of the tubular flow chamber designed as a gassing section adjoins a pressure chamber,
the pressure chamber includes the inlet opening for the gas and adjoins the segment of the tubular flow chamber designed as a gassing section in such a way that the gas fed through the inlet opening under pressure enters the tubular flow chamber through the gas-permeable porous wall and, in the tubular flow chamber, mixes with the foamable liquid in such a way that foam is formed, and
the gas feeding device and the liquid feeding device are designed in such a way that the pressure of the gas fed to the pressure chamber can be set in such a way that the pressure is greater than the pressure exerted on the gas-permeable porous wall by the liquid and that a desired ratio of fed gas to fed liquid is achieved.

2. The foam generator according to claim 1, wherein the gas feeding device and the liquid feeding device are designed in such a way that the pressure of the gas fed to the pressure chamber can be set in such a way that the pressure is 0.5 to 2 bars greater than the pressure of the liquid.

3. The foam generator according to claim 1, wherein the pressure chamber at least partially surrounds the flow chamber.

4. The foam generator according to any of claim 1 wherein the segment of the tubular flow chamber designed as a gassing section has a constant flow cross-section.

5. The foam generator according to claim 4, wherein the segment of the tubular flow chamber designed as a gassing section has a circular cross-section.

6. The foam generator according to any of claim 1 wherein the segment of the tubular flow chamber designed as a gassing section is a hollow cylinder having a gas-permeable porous wall and extending between the inlet opening for the foamable liquid and the foam outlet opening.

7. The foam generator according to claim 6, wherein the hollow cylinder has a gas-permeable porous wall of constant thickness.

8. The foam generator according to claim 1 wherein the gas is air and in that the gas feeding device comprises a compressor.

9. The foam generator according to claim 1 wherein the foamable liquid is a water/surfactant mixture and the liquid feeding device comprises a water/surfactant mixing device, by which the quantitative ratio of water and surfactant can be set.

10. A method for conditioning removed soil material as a supporting medium for an earth pressure balance shield of a tunnel boring machine, comprising:
removing soil and feeding the removed soil to an excavation chamber of the tunnel boring machine,
depending on the quality of the removed soil, providing a foam
feeding a foamable liquid to a foam generator at one end of a tubular flow chamber provided in the at least one foam generator, and
mixing a gas with the foamable liquid in such a way that foam is formed and feeding the foam to a segment of the tubular flow chamber designed as a gassing section through the gas-permeable porous wall thereof, and the gas is fed, at a pressure greater than the pressure exerted on the gas-permeable porous wall by the liquid, to a pressure chamber which encloses the segment designed as a gassing section,
depending on the quality of the removed soil, providing the at least one foam generator having the gassing section of a specified length, of a specified flow cross-section, and of a specified pore size and pore density and the ratio of fed gas to fed liquid is set in such a way that a desired structure and size of the foam bubbles result, and
feeding the foam exiting at the other end of the tubular flow chamber to the excavation chamber and mixing the foam exiting from the tubular flow chamber with the removed soil.

11. The method of conditioning according to claim 10, wherein the gas is fed to the pressure chamber at a pressure 0.5 to 2 bars greater than the pressure of the liquid.

12. The method of conditioning according to claim 11, wherein the foam is fed to the excavation chamber at a pressure 1 to 2 bars greater than the pressure in the excavation chamber.

13. The method of conditioning according to claim 10 wherein the foam exiting from the tubular flow chamber is fed to a plurality of injection points in the excavation chamber.

14. The method of conditioning according to claim 13, wherein the foam exiting from the tubular flow chamber is fed to injection points on a cutting wheel and also to a side of a pressure wall facing the excavation chamber.

15. The method of conditioning according to claim 14, wherein the foam exiting from the tubular flow chamber is additionally fed to injection points in a screw conveyor which conveys the removed soil from the excavation chamber.

16. The method of conditioning according to claim 10 wherein a solid material is fed together with the foamable liquid to the foam generator at one end of the tubular flow chamber.

17. The method of conditioning according to claim 16, wherein the solid material contains a bentonite powder or a bentonite granulate.

18. The method of conditioning according to claim 10, wherein depending on the quality of the removed soil, the foam generator having a gassing section of a specified length, of a specified flow cross-section, and of a specified pore size and pore density is provided by selecting a hollow cylinder serving as a gassing section for the foam generator on the basis of selected parameters of the removed soil, the hollow cylinder having a specified length and specified internal cross-section with a gas-permeable porous wall of specified pore size and pore density.

19. The method of conditioning according to claim 18, wherein from a plurality of gassing sections arranged parallel in terms of flow one gassing section with the selected parameters is selected by shutting off the feeding of liquid and gas to the other gassing sections.
